(19) United States
(12) Patent Application Publication
(10) Pub. No.: US 2026/0081300 A1
(43) Pub. Date: Mar. 19, 2026

(54) SECONDARY BATTERY AND BATTERY ASSEMBLY

(71) Applicant: SAMSUNG SDI CO., LTD., Yongin-si (KR)

(72) Inventor: Jeseong KIM, Yongin-si (KR)

(21) Appl. No.: 19/057,018

(22) Filed: Feb. 19, 2025

(30) Foreign Application Priority Data
Sep. 13, 2024 (KR) 10-2024-0125973

(51) Int. Cl. H01M 50/383; H01M 50/204; H01M 50/367; H01M 10/613

(52) U.S. Cl. CPC H01M 50/383; H01M 50/204; H01M 50/367; H01M 10/613

(57) ABSTRACT

A battery assembly includes a case having an accommodation space therein, a plurality of cells in the accommodation space, the plurality of cells being arranged in a first direction, and an extinguishing tube in the accommodation space and extending along the first direction across the plurality of cells, the extinguishing tube being between two terminals exposed to outside of each of the plurality of cells, and the extinguishing tube being connectable to an extinguishing device.

### CROSS-REFERENCE TO RELATED APPLICATION

The present application claims priority to and the benefit of Korean Application No. 10-2024-0125973, filed on September 13, 2024, in the Korean Intellectual Property Office, the entire disclosure of which is incorporated by reference herein.

### BACKGROUND

### 1. Field

The present disclosure relates to a secondary battery and a battery assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An energy storage system (ESS) may refer to a system that stores produced electric energy using lithium-ion batteries, etc., and then allows it to be used when needed. These energy storage systems enable energy to be utilized efficiently at all stages of power generation, transmission, substation, distribution and reception. A battery assembly used in an energy storage system may include a plurality of secondary batteries.

The above information disclosed in this Background section is for enhancement of understanding of the background of the present disclosure, and therefore, it may contain information that does not constitute related (or prior) art.

### SUMMARY

A battery assembly, according to embodiments, includes a case having an accommodation space provided therein, a plurality of cells that are disposed in the accommodation space, and arranged in a first direction, and an extinguishing tube that is connected to an extinguishing device and disposed in the accommodation space, in which the extinguishing tube is disposed along the first direction across the plurality of cells and is disposed between two terminals exposed to outside of each of the plurality of cells.

In an embodiment, the extinguishing tube may receive the extinguishing agent discharged from the extinguishing device.

In an embodiment, a vertical level of an upper surface of the extinguishing tube may be the same as a vertical level of upper surfaces of the two terminals exposed to outside of each of the plurality of cells.

In an embodiment, the extinguishing tube may include a base including an injection port into which an extinguishing agent discharged from the extinguishing device is injected, and a discharge portion for discharging the injected extinguishing agent.

In an embodiment, the discharge portion may be located at a lower surface of the extinguishing tube.

In an embodiment, a material of the base may be different from a material of the discharge portion.

In an embodiment, a melting point of the discharge portion may be lower than a melting point of the base.

In an embodiment, the discharge portions may be spaced apart from each other at positions corresponding to the positions of each of the plurality of cells.

In an embodiment, a height of the extinguishing tube may be greater than a diameter of the injection port.

In an embodiment, when the discharge portion is melted, the extinguishing agent discharged from the extinguishing device may be supplied to at least some of the plurality of cells through a plurality of holes formed by the discharge portion being melted.

In an embodiment, a size of the hole formed by the discharge portion being melted may be smaller than a size of the injection port.

In an embodiment, a cap plate of each of the plurality of cells may include a vent portion positioned between the two terminals exposed to outside, the extinguishing tube may be disposed on the vent portion, and the vent portion may include a plurality of vent grooves.

In an embodiment, the vent portion may include an outer portion that is inclined downward from an upper surface of the cap plate, and a central portion that is connected to the outer portion at a center of the vent portion and is parallel to the upper surface of the cap plate.

In an embodiment, a plurality of vent grooves may be formed in each of the outer portion and the central side.

In an embodiment, at least a portion of a lower surface of the extinguishing tube may be in contact with the upper surface of the cap plate of each of the plurality of cells.

In an embodiment, a width of the extinguishing tube may be greater than a width of the vent portion.

In an embodiment, when at least some of the plurality of vent grooves may be ruptured, an extinguishing agent discharged from the extinguishing tube may be supplied to the interior of at least some of the plurality of cells through at least some of the ruptured vent grooves.

A secondary battery, according to embodiments, includes an electrode assembly including a positive electrode, a negative electrode, and a separator interposed between the positive electrode and the negative electrode, a case body in which the electrode assembly is accommodated, a cap plate that seals an opening of the case body, and two terminals that are electrically connected to the electrode assembly and coupled to the cap plate, each protruding to the same height from an upper surface of the cap plate, in which the cap plate includes a vent portion positioned between the two terminals, and the vent portion includes a plurality of vent grooves.

In an embodiment, the vent portion may include an outer portion that is inclined downward from an upper surface of the cap plate, and a central portion that is connected to the outer portion at a center of the vent portion and is parallel to the upper surface of the cap plate.

In an embodiment, a plurality of vent grooves may be formed in each of the outer portion and the central side.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a battery cell according to an embodiment of the present disclosure.

FIG. 2 is a cross-sectional view of a battery cell according to an embodiment of the present disclosure.

FIG. 3 is an exploded perspective view of a battery assembly according to an embodiment of the present disclosure.

FIG. 4 is a front view of an extinguishing tube disposed on a battery cell according to an embodiment of the present disclosure, viewed from the front.

FIG. 5 is a plan view of a battery cell viewed from above according to an embodiment of the present disclosure.

FIG. 6 is a perspective view of an extinguishing tube according to an embodiment of the present disclosure.

FIG. 7 is a view of an extinguishing tube disposed on a battery cell according to an embodiment of the present disclosure.

FIG. 8 is a diagram showing an example of a plurality of vent grooves being ruptured according to an embodiment of the present disclosure.

FIG. 9 is a diagram showing an example in which an extinguishing agent is discharged from the extinguishing tube according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

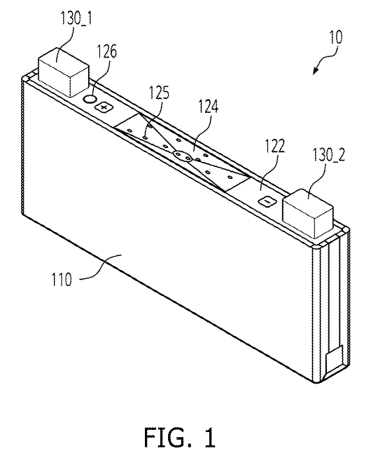

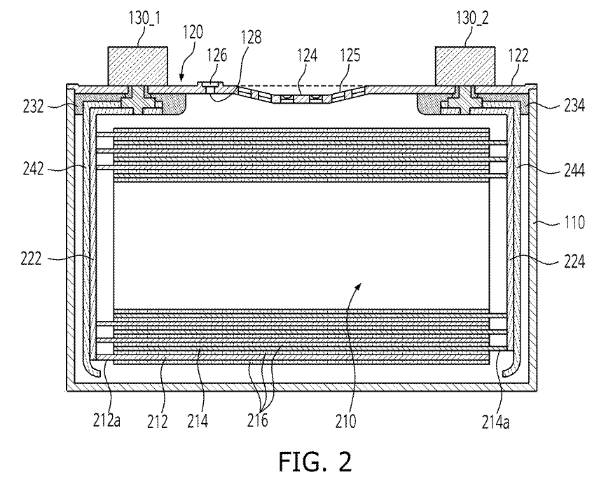

FIG. 1 is a diagram showing an example of a battery cell 10 according to an embodiment of the present disclosure, and FIG. 2 is a cross-sectional view showing an example of the battery cell 10 according to an embodiment of the present disclosure.

Referring to FIGS. 1 and 2, the battery cell 10 according to the present embodiment may include at least one electrode assembly 210 stacked or wound with a separator 216 as an insulator between a positive electrode 212 and a negative electrode 214, a case body 110 in which the electrode assembly 210 is received (or accommodated) therein, and a cap assembly 120 coupled to an opening of the case body 110.

Each of the positive electrode 212 and the negative electrode 214 may include a current collector made of a thin metal foil having a coated portion on which an active material is coated and an uncoated portion on which an active material is not coated. The positive electrode 212 and the negative electrode 214 may be wound after interposing the separator 216, which is an insulator, therebetween. However, the electrode assembly 210 may have a structure in which the positive electrode 212 and the negative electrode 214, each made of a plurality of sheets, are alternately stacked with a separator interposed therebetween.

The case body 110 forms the overall outer appearance of the battery cell 10 and may be made of a conductive metal such as aluminum, aluminum alloy, or nickel-plated steel. In some embodiments, the case body 110 may provide a space in which the electrode assembly 210 is accommodated.

The cap assembly 120 may include a cap plate 122 covering an opening of the case body 110, and the case body 110 and the cap plate 122 may be made of a conductive material. Here, the positive and negative electrode terminals 130_1, 130_2 electrically connected to the positive electrode 212 and the negative electrode 214, respectively, may be installed to penetrate (or extend through) the cap plate 122 and protrude outwardly therethrough.

In some embodiments, outer peripheral surfaces (e.g., circumferential surfaces) of upper pillars of the positive and negative electrode terminals 130_1 and 130_2 protruding outwardly from the cap plate 122 may be threaded and may be fixed to the cap plate 122 by utilizing nuts.

In some embodiments, the cap plate 122 may be made of a thin plate and may be coupled to the opening of the case body 110, and an electrolyte injection port 128 into which a sealing stopper 126 may be installed may be located (e.g., formed) in the cap plate 122, and a vent portion 124 having a notch may be installed.

The positive and negative terminals 130_1, 130_2 may be electrically connected to a current collector including positive and negative current collectors 222 and 224 (hereinafter referred to as positive and negative current collectors) by being bonded or coupled (e.g., by welding) to the positive uncoated portion 212a and the negative uncoated portion 214a, respectively.

For example, the positive and negative electrode terminals 130_1, 130_2 may be coupled by welding to the positive and negative electrode current collectors 222, 224 respectively. However, the positive and negative electrode terminals 130_1, 130_2 and the positive and negative electrode current collectors 222, 224 may be integrally formed in one or more embodiments.

In some embodiments, an insulation member may be installed between the electrode assembly 210 and the cap plate 122. The insulation member may include first and second lower insulation members 232, 234, and each of the first and second lower insulation members 232, 234 may also have a portion located between the electrode assembly 210 and the cap plate 122.

In some embodiments, according to one or more embodiments of the present disclosure, one end of a separation member may face one side of the electrode assembly 210 and may be installed between the insulation member and the positive or negative electrode terminals 130_1 and 130_2. In one or more embodiments, the separation member may include first and second separation members 242 and 244.

In such an embodiment, first ends of the first and second separation members 242 and 244 installed to face one side of the electrode assembly 210 may be respectively installed between the first and second lower insulation members 232 and 242 and the positive and negative electrode terminals 130_1 and 130_2. Accordingly, the positive and negative electrode terminals 130_1, 130_2, which may be coupled by welding to the positive and negative electrode current collectors 222 and 224, may be coupled to first ends of the first and second lower insulation members 232 and 234 and the first and second separation members 242 and 244.

In an embodiment, the two terminals 130_1, 130_2 may be formed to be exposed outward from the upper surface of the cap plate 122. For example, both terminals 130_1, 130_2 may protrude from the upper surface of the cap plate 122 to the same height.

In an embodiment, the cap plate 122 may include the vent portion 124 positioned between the two terminals 130_1, 130_2 each protruding from the upper surface of the cap plate 122. Here, the vent portion 124 may include a plurality of vent grooves 125. Notches may be formed in the plurality of vent grooves 125. Accordingly, when the pressure (e.g., internal gas pressure) within the case body 110 increases due to thermal runaway of the battery cell 10, at least some of the plurality of vent grooves 125 may be ruptured. Accordingly, gas within the case body 110 may be discharged to the outside of the battery cell 10.

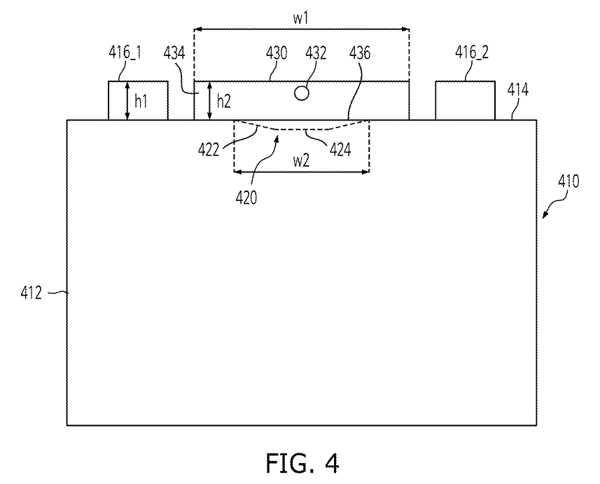

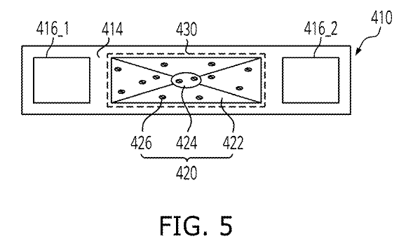

In an embodiment, the vent portion 124 may be recessed inwardly into the case body 110. For example, the vent portion 124 may include an outer portion that is inclined downward from the upper surface of the cap plate 122, and a central portion that is connected to the outer portion at the center of the vent portion 124 and is parallel to the upper surface of the cap plate 122. As the vent portion 124 is recessed inwardly into the case body 110, an extinguishing agent sprayed toward the vent portion 124 may flow down to the central portion through the slope of the outer portion. Examples of such a vent portion 124 are described in detail later with reference to FIGS. 4 and 5.

The battery cell 10 may be a lithium battery cell, a sodium battery cell, etc. However, the battery cell 10 may include any suitable battery cell that may repeatedly provide electricity by charging and discharging. In an embodiment, when the battery cell 10 is a lithium battery cell, it may be used in an electric vehicle (EV) because it has excellent life characteristics and high-rate characteristics. For example, it may be used in hybrid vehicles such as plug-in hybrid electric vehicles (PHEV). In some embodiments, lithium battery cells may be used in applications that require large amounts of power storage. For example, it may be used in electric bicycles, power tools, and energy storage systems (ESS).

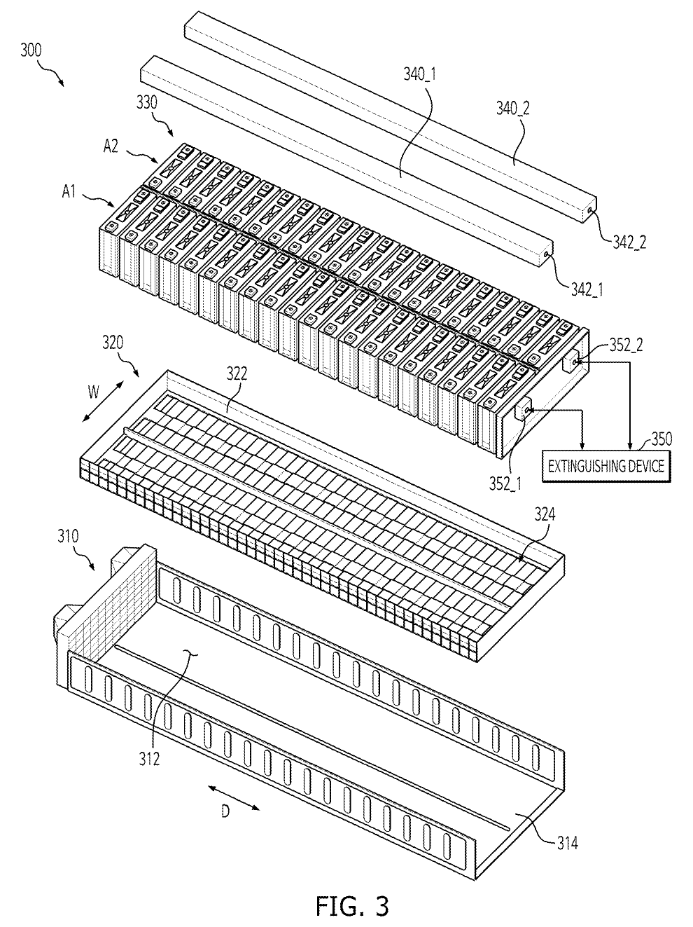

FIG. 3 is an exploded perspective view showing an example of a battery assembly 300 according to an embodiment of the present disclosure.

Referring to FIG. 3, in an embodiment, a battery assembly 300 (e.g., a battery module) may include a case 310 having an accommodation space 312 provided therein, a plurality of cells 330 (e.g., battery cells 10 of FIG. 1) disposed in the accommodation space 312 and arranged in a first direction (e.g., a longitudinal direction D of the case 310), and extinguishing tubes 340_1, 340_2 connected (e.g., connectable) to an extinguishing device 350, at least a portion of which is disposed in the accommodation space 312. Here, the first direction (e.g., the longitudinal direction D) of the case 310 may refer to a direction parallel to a long portion based on the upper surface of the case 310. In some embodiments, the second direction (e.g., a width direction W) of the case 310 may refer to a direction parallel to a short portion based on the upper surface of the case 310.

In an embodiment, the plurality of cells 330 may be, e.g., circular, square, pouch cells, etc. In some embodiments, the accommodation space 312 of the case 310 may be transformed into various sizes and shapes depending on the type and shape of the plurality of cells 330.

In an embodiment, the plurality of cells 330 may be disposed side by side along the longitudinal direction D of the case 310, e.g., the plurality of cells 330 may be arranged to have large surfaces thereof adjacent to each other along the longitudinal direction D of the case 310. Any suitable number of cells 330 may be disposed side by side along the longitudinal direction D of the case 310, e.g., the cells 330 may be disposed side by side to form a first group of cells A1 and a second group of cells A2 adjacent to each other in the width direction W. In another example, the plurality of cells 330 may include three or more cell groups disposed side by side in the width direction W. In some embodiments, the plurality of cells 330 may be arranged as shown in FIG. 3, e.g., cells in the first group of cells A1 may be arranged to have short sides thereof adjacent to short sides of cells in the second group of cells A2 in the width direction W.

In an embodiment, the extinguishing tubes 340_1, 340_2 may be disposed (e.g., may extend lengthwise) along the first direction (e.g., the longitudinal direction D) across the plurality of cells 330. For example, referring to FIG. 3, the extinguishing tubes 340_1, 340_2 may extend (e.g., continuously extend) over top surfaces of the plurality of cells 330 (e.g., over surfaces of the plurality of cells 330 that include the vent portions). The extinguishing tubes 340_1, 340_2 may be disposed between the two terminals exposed to outside of each of the plurality of cells 330, respectively, e.g., each of the extinguishing tubes 340_1, 340_2 may vertically overlap regions including the vent portions between respective terminals of the plurality of cells 330 in each of the corresponding group of cells.

For example, in some embodiments, the plurality of cells 330 may include the first group of cells A1 and the second group of cells A2 arranged (e.g., extending lengthwise) in the first direction (e.g., the longitudinal direction D). In this case, the extinguishing tubes 340_1, 340_2 may be disposed above the first group of cells A1 and the second group of cells A2, respectively. For example, a first extinguishing tube 340_1 may be disposed above the first group of cells A1 (e.g., between the two terminals of the first group of cells A1) to extend over all the cells in the first group of cells A1, and a second extinguishing tube 340_2 may be disposed above the second group of cells A2 (e.g., between the two terminals of the second group of cells A2) to extend over all the cells in the second group of cells A2.

In an embodiment, the length of the first extinguishing tube 340_1 in the first direction may correspond to (e.g., equal) the length of the first group of cells A1 in the first direction. In some embodiments, the length of the first extinguishing tube 340_1 in the second direction may be shorter than the length of the first group of cells A1 in the second direction. For example, the configuration of the second extinguishing tube 340_2 in terms of length and width in the first and second directions, respectively, may be the same as that of the first extinguishing tube 340_1. For example, the first and second extinguishing tubes 340_1 and 340_2 may be accommodated above the plurality of cells 330 inside the case 310, e.g., sidewalls of the case 310 may extend above the plurality of cells 330 to laterally overlap sidewalls of the first and second extinguishing tubes 340_1 and 340_2.

In an embodiment, the first and second extinguishing tubes 340_1 and 340_2 may receive (e.g., contain or accommodate) the extinguishing agent discharged from the extinguishing device 350. Here, the first and second extinguishing tubes 340_1 and 340_2 may include first and second injection ports 342_1 and 342_2 into which the extinguishing agent discharged from the extinguishing device 350 is injected, respectively. In some embodiments, first and second connecting pipes 352_1 and 352_2 disposed on the outside of the case 310 may be connected to the extinguishing device 350, and the first and second injection ports 342_1 and 342_2 may be connected to the first and second connecting pipes 352_1 and 352_2, respectively. For example, referring to FIG. 3, when the first and second extinguishing tubes 340_1 and 340_2 are accommodated on the plurality of cells 330 (i.e., in an assembled battery assembly), the first and second injection ports 342_1 and 342_2 at sides of the first and second extinguishing tubes 340_1 and 340_2, respectively, may face and may be aligned with the first and second connecting pipes 352_1 and 352_2 in the case 310, respectively. Accordingly, the extinguishing agent may be discharged from the extinguishing device 350 and injected into the first and second extinguishing tubes 340_1 and 340_2 through the first and second connecting pipes 352_1 and 352_2, respectively, and the first and second injection ports 342_1 and 342_2, respectively. For example, the extinguishing agent may be injected from the extinguishing device 350 into the first extinguishing tube 340_1 through the first connecting tube 352_1 and the first injection port 342_1.

In an embodiment, each of the first and second extinguishing tubes 340_1 and 340_2 may include a base (e.g., 434 in FIG. 4), discharge portions for discharging the extinguishing agent (e.g., 436 in FIG. 4), and the first and second injection ports 342_1 and 342_2, respectively. Here, the discharge portions may be located on the lower surfaces of the first and second injection ports 342_1 and 342_2, e.g., on surfaces of the first and second injection ports 342_1 and 342_2 facing the cells 330, as will be described in more detail below with reference to FIG. 4. The material of the discharge portion may be different from the material of the base, and the melting point of the discharge portion may be lower than the melting point of the base. For example, the melting point of the discharge portion may be 80 °C to 300 °C, and may vary depending on the material of the discharge portion.

In an embodiment, the material of the discharge portion may be a material that melts at a temperature of heat generation due to thermal runaway of the cell. Examples of the material of the discharge portion include at least one of polypropylene (PP), linear low density polyethylene (LLDPE), polyvinyl chloride (PVC), polyamide 6 (PA6), or polyamide 66 (PA66).

In an embodiment, the discharge portions may be spaced apart from each other at positions corresponding to (e.g., overlapping) the positions of the plurality of cells 330. When at least some of the plurality of cells 330 undergo thermal runaway, the discharge portion may melt before the base due to heat generated from at least some of the plurality of cells 330. Accordingly, the extinguishing agent discharged from the extinguishing device 350 may be supplied to at least some of the plurality of cells 330 through the plurality of holes formed by the melted discharge portion.

In an embodiment, the extinguishing agent may be a material capable of extinguishing a fire caused by thermal runaway of each of the plurality of cells 330. Examples of the extinguishing agent may include solid, liquid and gaseous substances having a cooling effect, such as carbon dioxide extinguishing agents and halogen extinguishing agents for gases, phosphate extinguishing agents and bicarbonate extinguishing agents for solids, and acid-alkali extinguishing agents, strengthened liquid extinguishing agents, and foam extinguishing agents for liquids. For example, the extinguishing agent may be heptafluoropropane, a water-based extinguishing agent for cooling extinguishment, and 1,1,1,2,3,3,3-hexafluoropropane. In some embodiments, an appropriate extinguishing agent may be determined based on the cell capacity to prevent thermal runaway transition.

In an embodiment, the battery assembly 300 may further include a lower panel 320 installed between the lower plate 314 of the case 310 and the plurality of cells 330 to support the lower portions of the plurality of cells 330. Here, the lower panel 320 may include a border member 322 that protrudes upward from the border (e.g., edge) of the panel body 324 and supports (e.g., and surrounds) the side surfaces of the plurality of cells 330. The lower panel 320 may block the extinguishing agent discharged from the melted extinguishing tube 340 from moving to the lower plate 314.

By the above described configuration, the extinguishing agent may be supplied to a cell where thermal runaway has occurred, among the plurality of cells 330. Accordingly, a cell in which thermal runaway has occurred may be prevented from transmitting thermal runaway to adjacent cells.

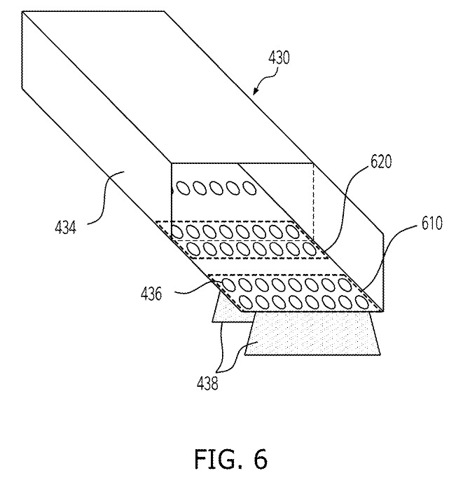

FIG. 4 is a front view of an extinguishing tube 430 disposed on a cell 410 according to an embodiment of the present disclosure, viewed from the front. FIG. 5 is a plan view showing an example of the cell 410 viewed from above, according to an embodiment of the present disclosure. FIG. 6 is an enlarged partial perspective view of the extinguishing tube 430 according to an embodiment of the present disclosure. The extinguishing tube 430 and the cell 410 in FIGS. 4-6 may be examples of the first extinguishing tube 340_1 and the cell 330 in FIG. 3.

In an embodiment, referring to FIG. 4, the cell 410 (e.g., the cell 330 of FIG. 1) may include a case body 412 in which an electrode assembly, including a positive electrode, a negative electrode, and a separator interposed between the positive electrode and the negative electrode, is accommodated, a cap plate 414 sealing an opening of the case body 412, and two terminals 416_1, 416_2 that are electrically connected to the electrode assembly and coupled to the cap plate 414 (e.g., each of the two terminals 416_1, 416_2 protruding to a same height from the upper surface of the cap plate 414). For example, the cap plate 414 may include a vent portion 420 positioned between the two terminals 416_1, 416_2. In some embodiments, the extinguishing tube 430 may be disposed on the vent portion 420, e.g., the extinguishing tube 430 may overlap and completely cover the vent portion 420. Accordingly, the extinguishing tube 430 may be located between the two terminals 416_1, 416_2.

In an embodiment, the vertical level h2 of the upper surface of the extinguishing tube 430 may be the same as the vertical level h1 of the upper surface of both terminals 416_1, 416_2. In some embodiments, the width w1 of the extinguishing tube 430 may be larger than the width w2 of the vent portion 420. In some embodiments, at least a portion of the lower surface of the extinguishing tube 430 may be in contact (e.g., direct contact) with the upper surface of the cap plate 414. Accordingly, the extinguishing tube 430 in contact with the upper surface of the cap plate 414 may support (e.g., press) the cap plate 414 downward, thereby preventing the cap plate 414 from being ejected due to thermal runaway of the cell 410.

In an embodiment, referring to FIGS. 4 and 5, the vent portion 420 may be a concave portion that bends toward the interior of the case body 412 from the upper surface of the cap plate 414, e.g., the entirety of the vent portion 420 may be concave and within the interior of the case body 412 (indicated by a dashed line in FIG. 4). For example, the vent portion 420 may include an outer portion 422 that is inclined downward from the upper surface of the cap plate 414, and a central portion 424 that is connected to the outer portion 422 at the center of the vent portion 420 and is parallel to the upper surface of the cap plate 414. In some embodiments, the vent portion 420 may include a plurality of vent grooves 426. Here, a plurality of vent grooves 426 may be formed in each of the outer portion 422 and the central portion 424.

In an embodiment, the central portion 424 may prevent components within the cell 410 from rising toward the cap plate 414 and from blocking the plurality of vent grooves 426 formed in the outer portion 422. For example, gas may be potentially generated inside the case body 412 due to thermal runaway of the cell 410, etc. When the gas pressure inside the case body 412 increases, components (e.g., an electrode assembly, etc.) inside the cell 410 may rise toward the cap plate 414. In this case, the flat central portion 424 may block the rise of the component. In some embodiments, extinguishing agents may be injected through the plurality of vent grooves 426 formed on the outer portion 422.

In an embodiment, a notch may be formed in each of the plurality of vent grooves 426. When the internal gas pressure of the cell 410 increases due to thermal runaway or the like, at least some of the plurality of vent grooves 426 may be ruptured (e.g., may be rupturable).

In an embodiment, referring to FIGS. 4 and 6, the extinguishing tube 430 may receive the extinguishing agent discharged from the extinguishing device. Here, the extinguishing tube 430 may include the base 434 with the injection port 432, into which an extinguishing agent discharged from an extinguishing device is injected, and the discharge portion 436 for discharging the injected extinguishing agent toward the cell 410. The discharge portion 436 may be located on the lower surface of the extinguishing tube 430, e.g., on a surface facing the cell 410. For example, referring to FIGS. 4 and 6, the base 434 may include the exterior top and side surfaces of the extinguishing tube 430, and the discharge portion 436 may be in the bottom surface of the extinguishing tube 430.

In an embodiment, the material of the base 434 may be different from the material of the discharge portion 436. Here, the melting point of the discharge portion 436 may be lower than the melting point of the base 434. For example, the melting point of the discharge portion 436 may be 80°C to 300°C, and may vary depending on the material of the discharge portion 436. Accordingly, when the temperature of the cell 410 rises due to thermal runaway, etc., the discharge portion 436 may melt (e.g., may be meltable) before the base 434.

In an embodiment, the material of the discharge portion 436 may melt at a temperature of heat generation due to thermal runaway of the cell 410. Examples of the material of the discharge portion 436 may include at least one of polypropylene (PP), linear low density polyethylene (LLDPE), polyvinyl chloride (PVC), polyamide 6 (PA6), or polyamide 66 (PA66).

In an embodiment, a plurality of discharge portions 436 may be spaced apart from each other, and may be positioned at positions corresponding to the positions of the plurality of cells 410. For example, the plurality of discharge portions 436 may be arranged into a plurality of groups (e.g., a first group 610 and a second group 620) spaced apart from each other (e.g., along a longitudinal direction of the extinguishing tube 430), such that each of the groups may be positioned at positions corresponding to (e.g., vertically overlapping) the positions of the plurality of cells 410 (e.g., in a one-to-one correspondence).

For example, the first group 610 of discharge portions 436 may be disposed at a position corresponding to the position of the first cell, and the second group 620 of the discharge portions 436 may be disposed at a position corresponding to the position of the second cell adjacent to the first cell. For example, the spacing between the first group 610 and the second group 620 may be determined based on the distance between the plurality of cells arranged in the battery assembly. When the temperature of the first cell 410 rises due to thermal runaway or the like, the first group 610 of discharge portions 436 may melt (e.g., the discharge portions 436 may melt). Accordingly, the extinguishing agent 438 discharged from the extinguishing device through the discharge portions 436 (i.e., through a plurality of holes formed by melting the discharge portion) may be sprayed to the lower side of the extinguishing tube and supplied to the first cell. The size of these holes may be smaller than the size of the injection port 432, so that the extinguishing agent 438 may be effectively sprayed.

In an embodiment, when at least some of the plurality of vent grooves 426 are ruptured (FIG. 5), the extinguishing agent 438 discharged from the extinguishing tube 430 may be supplied to the interior of the cell 410 through at least some of the ruptured vent grooves 426. In this process, the extinguishing agent 438 discharged from the extinguishing tube 430 may flow down to the central portion 424 along the slope of the outer portion 422. Accordingly, the discharged extinguishing agent 438 may be concentrated in the vent portion 420 without waste.

In an embodiment, the extinguishing agent may be a material capable of extinguishing a fire caused by thermal runaway of the cell 410. Examples of the extinguishing agent may include solid, liquid and gaseous substances having a cooling effect, such as carbon dioxide extinguishing agents and halogen extinguishing agents for gases, phosphate extinguishing agents and bicarbonate extinguishing agents for solids, and acid-alkali extinguishing agents, strengthened liquid extinguishing agents, and foam extinguishing agents for liquids. Specifically, it may be any one of heptafluoropropane, a water-based extinguishing agent for cooling extinguishment, and 1,1,1,2,3,3,3-hexafluoropropane. In some embodiments, an appropriate extinguishing agent may be determined based on the cell capacity to prevent thermal runaway transition.

By this configuration, the extinguishing agent may be injected into the cell due to the inclined outer portion of the vent portion of the cell. In some embodiments, since the extinguishing tubes are disposed adjacent to the cells, thermal runaway of the cells may be more easily reduced by the extinguishing agent discharged from the extinguishing tubes. Accordingly, the extinguishing function of the battery assembly may be improved.

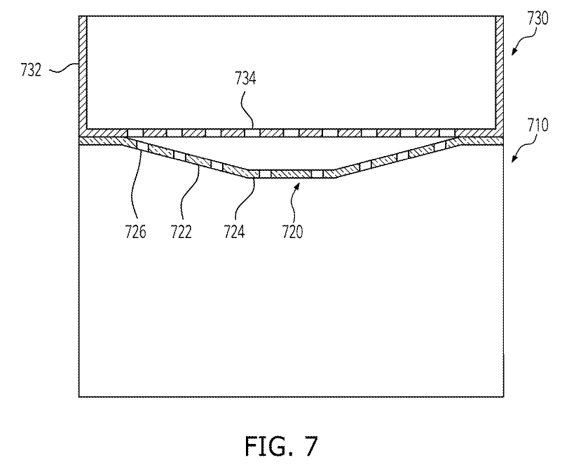

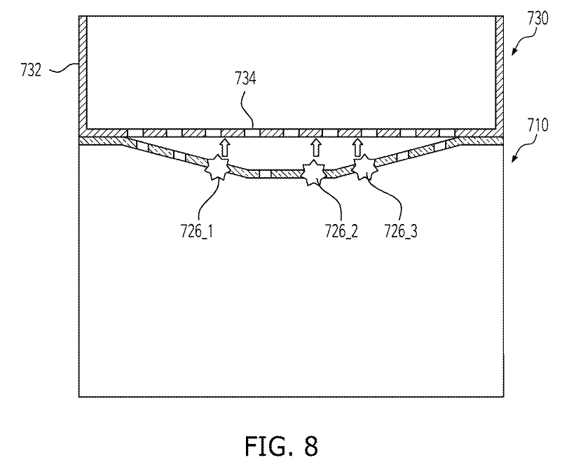

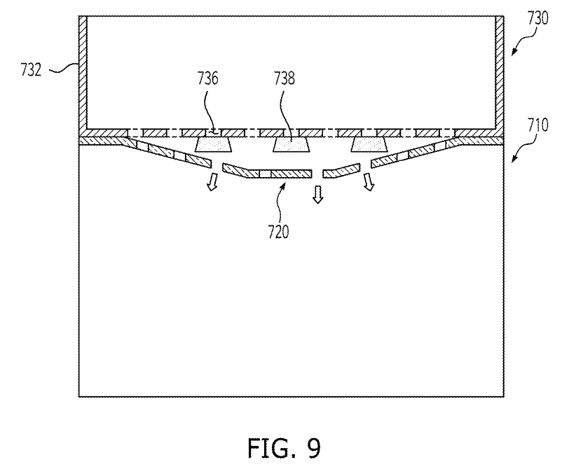

FIG. 7 is a diagram showing an example in which an extinguishing tube 730 (e.g., the extinguishing tube 430 of FIG. 4) is disposed on the cell 710, according to an embodiment of the present disclosure. FIG. 8 is a diagram showing an example of a plurality of vent grooves 726_1 to 726_3 being ruptured according to an embodiment of the present disclosure. FIG. 9 is a diagram showing an example in which an extinguishing agent 738 is discharged from the extinguishing tube 730 according to an embodiment of the present disclosure.

In an embodiment, referring to FIG. 7, the cell 710 may include a vent portion 720 in the cap plate. Here, the vent portion 720 may include an outer portion 722 that is inclined downward from the upper surface of the cap plate, and a central portion 724 connected to the outer portion 722 at the center of the vent portion 720. For example, as illustrated in FIG. 7, the central portion 724 may be parallel to the upper surface of the cap plate. In another example, the central portion 724 may be omitted, and the vent portion 720 may be formed in a V shape.

In an embodiment, the vent portion 720 may further include a plurality of vent grooves 726. Here, a notch may be formed in each of the plurality of vent grooves 726. When the pressure inside the cell 710 increases, at least some of the plurality of vent grooves 726 may rupture.

In an embodiment, the extinguishing tube 730 may be positioned on the vent portion 720. Here, the extinguishing tube 730 may receive the extinguishing agent discharged from the extinguishing device. In some embodiments, the extinguishing tube 730 may include a base 732 including an injection port into which an extinguishing agent discharged from the extinguishing device is injected, and a discharge portion 734 for discharging the injected extinguishing agent. Here, the base 732 may refer to a portion excluding the discharge portion 734.

In an embodiment, the discharge portion 734 may be positioned on the lower surface of the extinguishing tube 730. For example, the discharge portion 734 may be disposed on the lower surface of the extinguishing tube 730 corresponding to the vent portion 720. In some embodiments, the melting point of the discharge portion 734 may be lower than the melting point of the base 732.

In an embodiment, referring to FIG. 8, at least some of the plurality of vent grooves 726 may rupture. For example, when the internal pressure increases due to thermal runaway of the cell 710, the first vent groove 726_1 to the third vent groove 726_3 may be ruptured. Accordingly, high temperature gas present inside the cell 710 may be discharged to the outside of the cell 710 through the ruptured first to third vent groove 726_1, 726_2, and 726_3. These high temperature gases may heat the discharge portion 734 located on the lower surface of the extinguishing tube 730 (and vertically overlapping and covering the vent grooves 726 of the vent portion 720.

In an embodiment, referring to FIG. 9, the discharge portion 734 may be melted to form a plurality of holes 736. In this case, the extinguishing agent 738 contained in the extinguishing tube 730 may be discharged to the outside through the plurality of holes 736, e.g., so the plurality of holes 736 may be between and in fluid communication with the extinguishing tube 730 and the plurality of cells 710. Accordingly, the extinguishing agent 738 may be supplied to the cell 710 located at the lower side of the extinguishing tube 730. These extinguishing agents 738 may be injected into the cell 710 to reduce the temperature of the cell 710.

By way of summation and review, when thermal runaway occurs in a secondary battery, fire or explosion may occur and the thermal runaway may spread to adjacent secondary batteries. In the event of a thermal runaway transition, it may be difficult to extinguish the fire due to the high fire intensity and risk of subsequent explosion.

According to some embodiments of the present disclosure, the extinguishing agent may be supplied to a cell where thermal runaway has occurred, among a plurality of cells. Accordingly, a cell in which thermal runaway has occurred may be prevented from transmitting thermal runaway to adjacent cells.

According to some embodiments of the present disclosure, the extinguishing agent may be injected into the cell due to the inclined outer portion of the vent portion of the cell. In addition, since the extinguishing tubes are disposed adjacent to the cells, thermal runaway of the cells may be more easily reduced by the extinguishing agent discharged from the extinguishing tubes. Accordingly, the extinguishing function of the battery assembly may be improved.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery assembly, comprising:
a case having an accommodation space therein;
a plurality of cells in the accommodation space, the plurality of cells being arranged in a first direction; and
an extinguishing tube in the accommodation space and extending along the first direction across the plurality of cells, the extinguishing tube being between two terminals exposed to an outside of each of the plurality of cells, and the extinguishing tube being connectable to an extinguishing device.

2. The battery assembly as claimed in claim 1, wherein the extinguishing tube receives an extinguishing agent discharged from the extinguishing device.

3. The battery assembly as claimed in claim 1, wherein a vertical level of an upper surface of the extinguishing tube is a same as a vertical level of upper surfaces of the two terminals exposed to the outside of each of the plurality of cells.

4. The battery assembly as claimed in claim 1, wherein the extinguishing tube includes:
a base including an injection port into which an extinguishing agent discharged from the extinguishing device is injected; and
a discharge portion that discharges the injected extinguishing agent.

5. The battery assembly as claimed in claim 4, wherein the discharge portion is on a lower surface of the extinguishing tube.

6. The battery assembly as claimed in claim 4, wherein a material of the base is different from a material of the discharge portion.

7. The battery assembly as claimed in claim 4, wherein a melting point of the discharge portion is lower than a melting point of the base.

8. The battery assembly as claimed in claim 4, wherein the discharge portion includes a plurality of discharge portions that are spaced apart from each other and are at positions corresponding to respective positions of the plurality of cells.

9. The battery assembly as claimed in claim 4, wherein a height of the extinguishing tube is greater than a diameter of the injection port.

10. The battery assembly as claimed in claim 4, wherein the discharge portion is meltable to define a plurality of holes between the extinguishing tube and the plurality of cells, the plurality of holes being in fluid communication with the extinguishing tube and the plurality of cells.

11. The battery assembly as claimed in claim 10, wherein a size of each of the plurality of holes is smaller than a size of the injection port.

12. The battery assembly as claimed in claim 1, wherein:
a cap plate of each of the plurality of cells includes a vent portion between the two terminals exposed to the outside,
the extinguishing tube is on the vent portion, and
the vent portion includes a plurality of vent grooves.

13. The battery assembly as claimed in claim 12, wherein the vent portion includes:
an outer portion inclined downward from an upper surface of the cap plate; and
a central portion that is connected to the outer portion at a center of the vent portion, the central portion being parallel to the upper surface of the cap plate.

14. The battery assembly as claimed in claim 13, wherein the plurality of vent grooves are in each of the outer portion and the central portion of the vent portion.

15. The battery assembly as claimed in claim 12, wherein at least a portion of a lower surface of the extinguishing tube is in contact with an upper surface of the cap plate of each of the plurality of cells.

16. The battery assembly as claimed in claim 12, wherein a width of the extinguishing tube is greater than a width of the vent portion.

17. The battery assembly as claimed in claim 12, wherein at least some of the plurality of vent grooves are rupturable, ruptured vent grooves being in fluid communication with the extinguishing tube and an interior of at least some of the plurality of cells.

18. A secondary battery, comprising:
an electrode assembly including a positive electrode, a negative electrode, and a separator between the positive electrode and the negative electrode;
a case body accommodating the electrode assembly;
a cap plate that seals an opening of the case body, the cap plate including a vent portion; and
two terminals electrically connected to the electrode assembly and coupled to the cap plate, each of the two terminals protruding to a same height from an upper surface of the cap plate, the vent portion being between the two terminals and including a plurality of vent grooves.

19. The secondary battery as claimed in claim 18, wherein the vent portion further includes:
an outer portion that is inclined downward from an upper surface of the cap plate; and
a central portion that is connected to the outer portion at a center of the vent portion, the central portion being parallel to the upper surface of the cap plate.

20. The secondary battery as claimed in claim 19, wherein the plurality of vent grooves are in each of the outer portion and the central portion.
